(19) United States
(12) Patent Application Publication
(10) Pub. No.: US 2010/0139662 A1
(43) Pub. Date: Jun. 10, 2010

(54) RESPIRATORY MASK

(75) Inventor: Eric Chang, Taichung Hsien (TW)

Correspondence Address: OCCHIUTI ROHLICEK & TSAO, LLP, 10 FAWCETT STREET, CAMBRIDGE, MA, 02138, US

(73) Assignee: Hsiner Co., Ltd., Taichung Hsien (TW)

(21) Appl. No.: 12/416,533

(22) Filed: Apr. 1, 2009

(30) Foreign Application Priority Data
Dec. 4, 2008 (TW) 097147139

(51) Int. Cl. A62B 18/08

(52) U.S. Cl. 128/206.27; 128/207.11

(57) ABSTRACT

A respiratory mask includes a teardrop-shaped front face member having a middle portion made of a transparent material and a lateral portion made of a colored material, and a rear cup member having a rear sealing portion adapted to contact a user's face, and a front portion connected to the front face member. The middle portion has a narrow top section and a wide bottom section. The lateral portion is connected laterally to the middle portion, and extends from one lateral side of the narrow top section, around the wide bottom section, and back to the other lateral side of the narrow top section. The middle and lateral portions are formed as a one-piece body. An air inlet is formed in the wide bottom section. Two strap-engaging portions are provided respectively on left and right sides of the lateral portion.

### BACKGROUND OF THE INVENTION

1. Field of the Invention

This invention relates to a mask, more particularly to a respiratory mask for a user suffering from sleep apnea.

2. Description of the Related Art

Loud snoring is a symptom that may indicate a person is suffering from sleep apnea. One effective way of treating that person is for him/her to wear a respiratory mask during sleep. A respiratory resuscitator is connected to the respiratory mask, and pumps a positive airway pressure into a person's nasal cavity and throat through the respiratory mask so as to keep the airway open and prevent the airway from collapsing. Thus, an upper respiratory tract can remain unobstructed, and a person's breathing can be smooth. This kind of machine that provides a positive airway pressure to the respiratory mask is known as a continuous positive airway pressure (CPAP) machine. According to some studies, the effectiveness of the treatment can reach more than 90%.

Although a person wearing such a respiratory mask can be effectively treated through the provision of the positive airway pressure by the CPAP machine to the respiratory mask, medical research reports point out that the acceptance of wearing a respiratory mask by people suffering from sleep apnea is not ideal. This has been attributed to the fact that such respiratory masks look like the ones used for critically ill patients in the hospital.

FIG. 1 illustrates a conventional respiratory mask 1 worn by a person suffering from sleep apnea. To prevent a user from associating the respiratory mask 1 with that used for critical patients in the hospital, different kinds of respiratory masks have been developed. These include respiratory masks made by Resmed and Respironics, each of which is designed to cover the nose and mouth of a user, and has an extruded transparent frame and a soft cover portion provided at one side of the transparent frame. The color tones and contour of the respiratory masks made by Resmed and Respironics are similar. Modern respiratory masks are more flawless and comfortable to wear, such as Resmed's Mirage Activa™ and Mirage Quattro™, the technical descriptions of which are respectively disclosed in U.S. Pat. Nos. 7,406,965 and 7,207,334. Although the frames of these respiratory masks are provided with color, the contours thereof are still similar to that of the conventional respiratory mask 1. Further, the purpose of the colored frame of each of these respiratory masks is to facilitate changing of the soft cover portion.

### SUMMARY OF THE INVENTION

Therefore, the object of the present invention is to provide a respiratory mask that has a contour distinctive from that of conventional respiratory masks so as to provide greater wear comfort and aesthetic appeal.

According to this invention, a respiratory mask comprises a mask body, an air inlet, and two strap-engaging portions. The mask body includes a teardrop-shaped front face member having a middle portion made of a transparent material and a lateral portion made of a colored material, and a rear cup member having a rear sealing portion adapted to contact a user's face, and a front portion connected to the front face member. The middle portion has a narrow top section and a wide bottom section. The lateral portion is connected laterally to the middle portion, and extends from one lateral side of the narrow top section, around the wide bottom section, and back to the other lateral side of the narrow top section. The middle portion and the lateral portion are formed as a one-piece body. The air inlet is formed in the wide bottom section. The strap-engaging portions are provided respectively on left and right sides of the lateral portion.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic front view of a conventional respiratory mask in a state of use;

FIG. 2 is a schematic front view of a respiratory mask according to the preferred embodiment of this invention; and

FIG. 3 is a schematic side view of the preferred embodiment.

### DETAILED DESCRIPTION OF THE PREFERRED EMBODIMENT

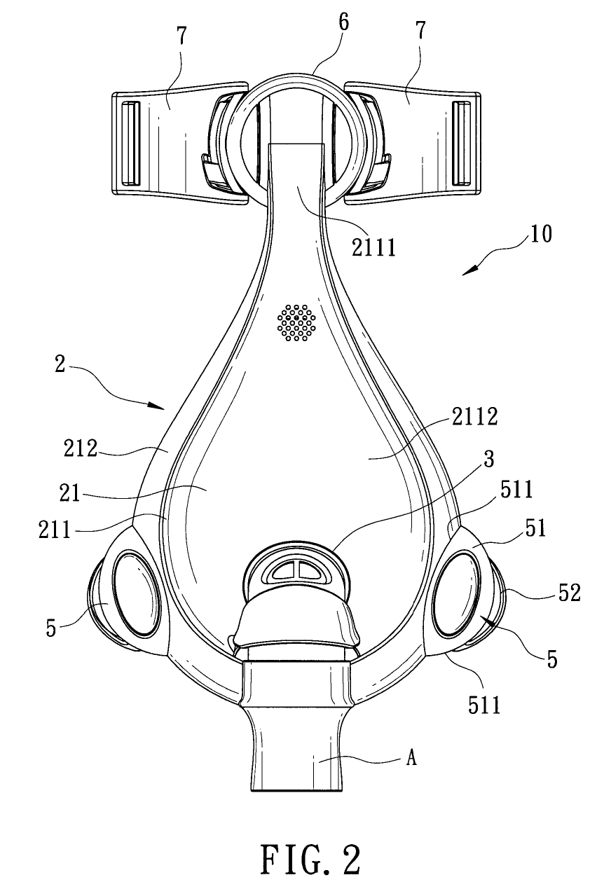

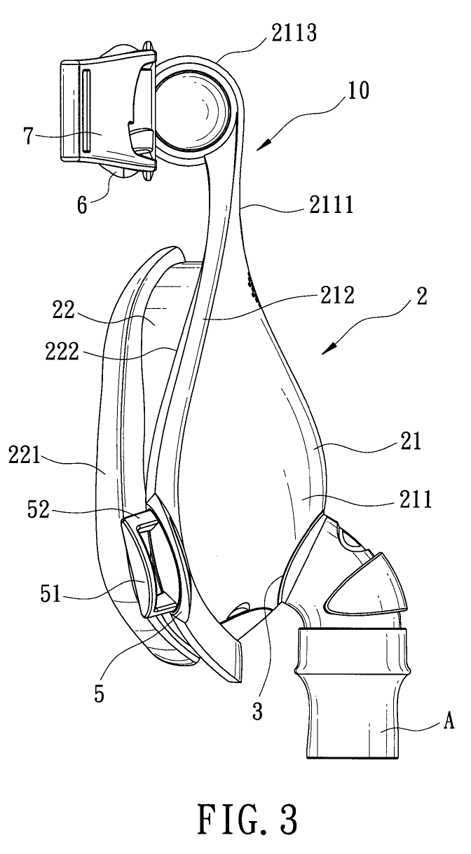

Referring to FIGS. 2 and 3, a respiratory mask 10 according to the preferred embodiment of the present invention is shown to comprise a mask body 2, an air inlet 3, two first strap-engaging portions 5, a forehead abutment portion 6, and two second strap-engaging portions 7.

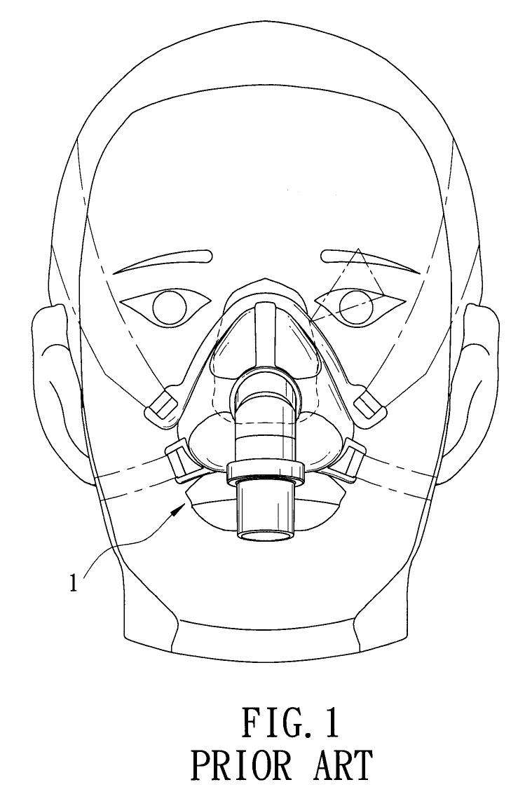

The mask body 2 includes a teardrop-shaped front face member 21 and a rear cup member 22. The front face member 21 has a middle portion 211 made of a transparent material, and a lateral portion 212 made of a colored material. The middle portion 211 has a narrow top section 2111 and a wide bottom section 2112. The narrow top section 2111 has a substantially circular hollow member 2113. The lateral portion 212 is connected laterally to the middle portion 211, and extends from one lateral side of the narrow top section 2111, around the wide bottom section 2112, and back to the other lateral side of the narrow top section 2111. The middle portion 211 and the lateral portion 212 are made by injection molding so as to form a one-piece, two-tone body. Hence, there is no seam formed between the middle portion 211 and the lateral portion 212, so that the respiratory mask 10 is easy to clean. Further, with the shape of the front face member 21 simulating a teardrop, the respiratory mask 10 of the present invention has a colored contour totally distinctive from that of the conventional respiratory mask 1 shown in FIG. 1. Hence, the appearance of the respiratory mask 10 of the present invention is effectively enhanced.

The rear cup member 22 has a rear sealing portion 221 adapted to contact a user's face, and a front portion 222 connected to the front face member 21.

The air inlet 3 is formed in the wide bottom section 2112 for connection with an air inlet tube (A).

The first strap-engaging portions 5 are provided respectively on left and right sides of the lateral portion 212. Each of the first strap-engaging portions 5 includes a rounded lug part 51 projecting outwardly from a respective one of the left and right sides of the lateral portion 212, and a strap-connecting part 52 projecting rearwardly from the rounded lug part 51. The rounded lug part 51 has two curved sides 511 having opposite ends connected to each other. Ends of a lower head strap (not shown) are connected respectively to the strap-connecting parts 52 of the first strap-engaging portions 5 to secure the respiratory mask 10 to a lower portion of the head of the user.

The forehead abutment portion 6 is connected to the hollow member 2113 of the narrow top section 2111, and is adapted to abut against the forehead of the user.

The second strap-engaging portions 7 are respectively connected to left and right sides of the forehead abutment portion 6. Ends of an upper head strap (not shown) are connected respectively to the second strap-engaging portions 7 to secure the respiratory mask 10 to an upper portion of the head of the user.

To summarize the aforementioned description, the middle and lateral portions 211, 212 of the teardrop-shaped front face member 21 are made by injection molding so as to form a one-piece, two-tone body, so that not only is cleaning of the respiratory mask 10 facilitated, but the shape of the respiratory mask 10 itself is also distinctive from the conventional and currently available respiratory masks. This second advantageous result is such that association of the respiratory mask 10 of the present invention can be diverted from that use for critical patients in the hospital.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A respiratory mask comprising:
a mask body including a teardrop-shaped front face member having a middle portion made of a transparent material and a lateral portion made of a colored material, and a rear cup member having a rear sealing portion adapted to contact a user's face, and a front portion connected to said front face member, said middle portion having a narrow top section and a wide bottom section, said lateral portion being connected laterally to said middle portion and extending from one lateral side of said narrow upper section, around said wide bottom section, and back to the other lateral side of said narrow top section, said middle portion and said lateral portion being formed as a one-piece body;
an air inlet formed in said wide bottom section; and
two first strap-engaging portions provided respectively on left and right sides of said lateral portion.

2. The respiratory mask of claim 1, wherein each of said strap-engaging portions includes a rounded lug part projecting outwardly from a respective one of said left and right sides of said lateral portion, and a strap-connecting part projecting rearwardly from said rounded lug part.

3. The respiratory mask of claim 1, further comprising a forehead abutment portion connected to said narrow top section.

4. The respiratory mask of claim 3, further comprising two second strap-engaging portions connected respectively to left and right sides of said forehead abutment portion.
